(19) United States
(12) Patent Application Publication
(10) Pub. No.: US 2003/0056796 A1
(43) Pub. Date: Mar. 27, 2003

(54) Bite guard and method of manufacture

(76) Inventor: Marla D. Conklin, Windsor, CO (US)

Correspondence Address: HENDERSON & STURM LLP, 1213 MIDLAND BUILDING, 206 SIXTH AVENUE, DES MOINES, IA, 50309-4076, US

(21) Appl. No.: 09/904,602

(22) Filed: Jul. 13, 2001

(51) Int. Cl. A61C 5/14

(52) U.S. Cl. 128/861

(57) ABSTRACT

A custom made bite guard construction (10) for relaxing a patient's temporal muscles (105) and providing relief from the strain of teeth clenching in the molar region (103) wherein the construction (10) includes a custom fit upper portion (11) and a custom fit lower portion 12 that partially cover only the bicuspid and anterior teeth of the upper (101) and lower (102) teeth arches and which are joined together by an intermediate bite portion (13) that creates a space (103) between the opposed teeth in the patient's molar region; and, the invention also includes the method employed in the fabrication of the bite guard construction (10).

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of teeth grinding prevention devices in general and in particular to a unique bite guard that not only prevents the clenching of the user's jaws and pinching or biting of the cheeks but also involves the novel method of manufacture of the mouth guard.

2. Description of Related Art

As can be seen by reference to the following U.S. Pat. Nos. 5,921,240; 4,304,227; 5,328,362; and, 5,823,193, the prior art is replete with myriad and diverse mouthpiece constructions to prevent jaw clenching, teeth grinding, snoring, etc.

While all of the aforementioned prior art constructions are more than adequate for the basic purpose and function for which they have been specifically designed, they are uniformly deficient with respect to their failure to provide a simple, efficient, and practical arrangement to relax a patient's temporal muscles and relieve the strain of teeth clenching in the patient's molar region by employing a custom made bite guard appliance whose design is intended to facilitate speech while wearing the appliance.

To date, no one has developed a custom made clear acrylic bite guard appliance nor provided a specific method for the fabrication of such a construction.

As a consequence of the foregoing situation, there has existed a longstanding need among dentists for a new and improved lightweight bite guard appliance having a slim truncated profile that leaves the patient's molar region exposed yet maintains the opposed tooth surfaces at a predetermined spacing from one another to provide the desired therapeutic results; and the provision of such a construction is the stated objective of the present invention.

### BRIEF SUMMARY OF THE INVENTION

Briefly stated, the custom made bite guard construction that forms the basis of the present invention comprises in general a custom fit upper portion, a custom fit lower portion and an intermediate portion that joins the upper portion to the lower portion and is designed and dimensioned to create a specific spacing between the opposed tooth surfaces in the patient's molar regions.

As will be explained in greater detail further on in the specification, both the custom fit upper and lower portions are fabricated by the same method to produce independent teeth arch coverings which are trimmed to remove entirely the covering material from the molar regions of the respective teeth arches as well as selected portions extending from the gum line to the incisal edge of the bicuspid and anterior teeth areas of the upper and lower portions.

The independent upper and lower portions are then mounted on a model set of teeth disposed in a bite articulator wherein the opposed surfaces of the upper and lower portions are further worked on to produce a generally smooth engagement between the opposed surfaces while still maintaining a desired combined thickness of the opposed surfaces.

At this juncture, the opposed surfaces are bonded together to form the intermediate portion of the finished custom made bite guard construction.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is an enlarged detail view of a user's clenched bite that places undue stress on jaw muscles and tooth enamel;

FIG. 2 is an enlarged detail relaxed view of the bite produced while wearing the protective bite guard of this invention;

FIG. 3 is an isolated perspective view of the finished bite guard construction;

FIG. 4 is a cross-sectional view of the bite guard construction taken through line 4-4 of FIG. 3; and,

FIG. 5 is a front elevation view of the bite guard engaged by the user's teeth.

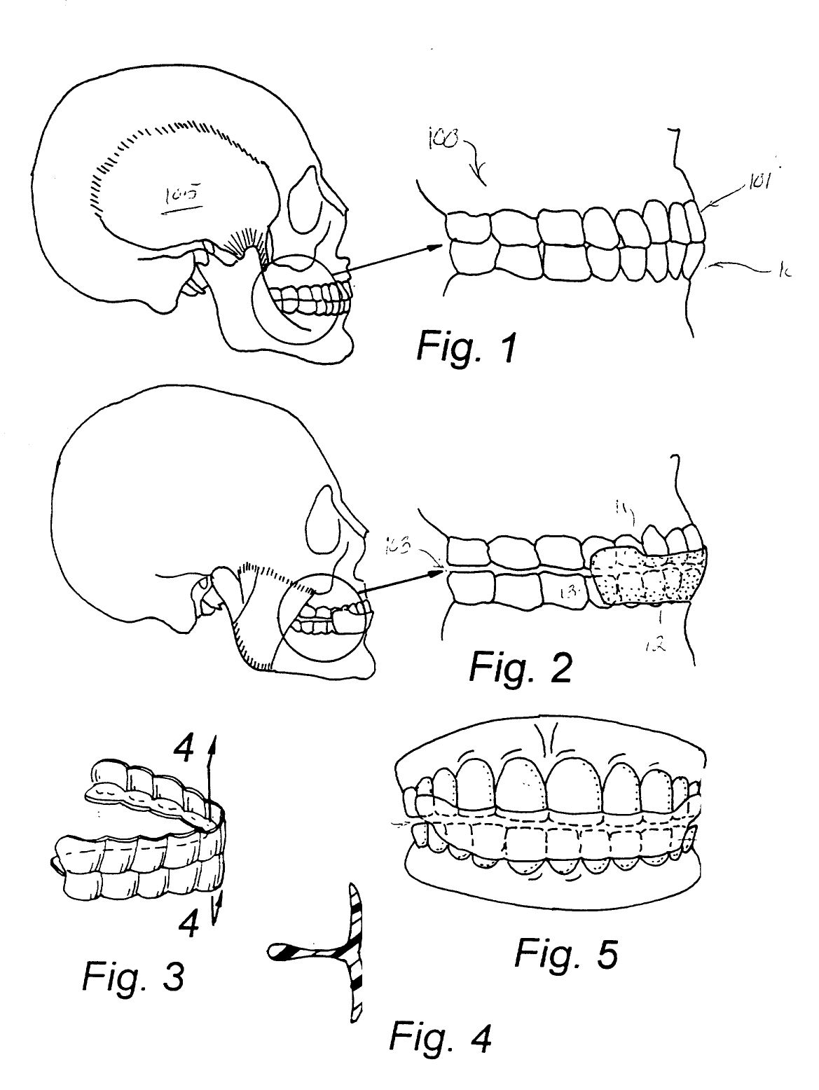

### DETAILED DESCRIPTION OF THE INVENTION

As can be seen by reference to the drawings, and in particularly to FIG. 2, the bite guard construction that forms the basis of the present invention is designated generally by the reference number 10. As can best be seen by reference to FIG. 3, the construction 10 includes an impression based upper portion 11 and an impression based lower portion 10 which are precisely formed in a specific manner and joined together at a bite junction 13 wherein the specific method of fabricating the bite guard construction 10 will now be described in detail.

The fabrication of the upper 11 and lower 12 portions of the bite guard construction 10 follows the same basic steps and will therefore be described in unison.

First of all, it is necessary to obtain alginate impressions of the full upper and lower arches of a patient's teeth. Then it is necessary to obtain a bite registration that is comfortable to the patient.

Once the bite registration has been established, it is then necessary to fabricate two sets of models of the patient's upper 101 and lower 102 arches. Then using the first set of models which have been individually prepared by trimming excess material and reaming holes in the bottom of them to allow proper suction in a vacuum former machine, we are ready to begin the actual formation of the bite guard construction.

At this point, the model of the upper arch 101 in the first set of models is inserted into a vacuum forming machine along with a 5″×5″.060 gauge sheet of thermoforming material such a clear acrylic or the like. The heater on the vacuum former is then turned on until the thermoforming material slopes approximately half way down to the model whereupon the vacuum is initiated to form the material precisely around the model.

The foregoing procedure is repeated again for the lower arch 102 and after the formed material on both the first set of models of the upper and lower arches has cooled, the excess material is removed from each half of the first set of models using a separating disc.

At this juncture, the coated material on the models of the upper and lower arch from the molars up to the bicuspid areas are removed while leaving 1 mm below the remaining teeth both front and back leaving the bicuspid area and all of the anterior teeth on both the upper and lower arch covered with material,

The next step involves removing selected portions of the coated material from the bicuspid and anterior teeth areas of the model; wherein, the coating material for the “CQ-1” maxillary teeth is removed from the gum line to incisal edge starting at canines to centrals 1-2 mm. The “CQ-2” lower cuspids to centrals are trimmed in the same manner which ultimately will allow the user to release their teeth from the finished bite guard construction 10 in order to speak. This ends the initial fabrication of the upper 11 and lower 12 portions of the bite guard construction 10.

Once this stage has been reached, it is then necessary to utilize the second set of models of the upper and lower arches and mount them for bite registration in the normal fashion such as by setting the “bite” in a Vertex bite articulator.

When the bite registration has been set, the upper 11 and lower 12 portions of the construction are independently mounted on the second set of models of the teeth arches; and, by using articulation paper between the contacting surfaces of the upper and lower portions 11 12 can be removed by grinding.

This grinding process will continue until either uniform marking by the articulation paper occurs or until a 1-2 mm space 103 between the molar regions of the upper 11 and lower 12 portions is achieved.

At this juncture, the bite portion 13 of the bite guard construction 10 is fabricated by coating the contacting surfaces of the upper 11 and lower 12 portions of the construction with a cyanoorylate gel as indicated by the dashed lines in FIG. 4, wherein the joined inwardly directed bite portion 13 completes the fabrication of the finished bite guard construction 10 which relaxes a patient's temporal muscles 105 and eliminates the strain of teeth clenching in the patient's molar region.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

1. An improved bite guard construction for relaxing a patient's temporal muscles and relieving the strain of teeth clenching in the molar region, wherein, the construction comprises
a custom fit upper portion that covers the bottom and at least a portion of the front of the bicuspid and anterior teeth on the upper arch of a patient's teeth;
a custom fit lower portion that covers the top and at least a portion of the front of the bicuspid and anterior teeth on the lower arch of a patient's teeth; and,
a bite portion which extends rearwardly in the patient's mouth and forms the operative connection between said upper and lower portions.

2. The construction as in claim 1; wherein, the maximum thickness of said bite portion is 2 mm.

3. The construction as in claim 2; wherein, the minimum thickness of said bite portion is 1 mm.

4. The construction as in claim 1; wherein, the bite portion has an average thickness of 1-2 mm.

5. The construction as in claim 1; wherein, only the bicuspid and anterior teeth of the patient are at least partially covered by said upper and lower portions of the construction.

6. The construction as in claim 5; wherein, the top of the upper portion is substantially spaced from the gum line of the patient's upper anterior teeth.

7. The construction as in claim 6; wherein, the bottom of the lower portion is slightly spaced from the gum line of the patient's lower anterior teeth.

8. A method of fabricating a custom fit bite guard construction for relaxing a patient's temporal muscles and relieving the strain of teeth clenching in the molar region comprising the steps of:
a) making a set of dental impressions of the patient's upper and lower teeth arches
b) fabricating two sets of models of the upper and lower teeth arches
c) drilling vacuum porting holes in the first set of models
d) in a sequential fashion, placing one half of the first set of models in a vacuum forming machine along with a sheet of thermoforming material, activating the heater in the vacuum forming machine followed by the vacuum to form the material around the selected model half to create a precise fit and removing the selected model half from the machine to cool;
e) repeating step d) for the other half of the first set of models;
f) removing the material entirely from the molar region and trimming the material from the bicuspid area and the anterior teeth from the gum line to the incisal edge;
g) installing the second set of models of the upper and lower teeth arches in a bite articulator and setting the bite registraation;
h) placing the upper and lower portions of the untrimmed material on the corresponding areas of the second set of models installed on the bite articulator;
i) using articulator paper to identify high spots and remove by grinding to establish maximum contact between said upper and lower portions while maintaining a 1-2 mm space between the molar region; and,
j) joining the contacting areas of said upper and lower portions together with a suitable bonding agent.

9. The method as in claim 8; wherein, said thermoforming material comprises clear acrylic.

10. The method as in claim 9; wherein said bonding agent comprises a cyanocrylates gel.
